(19) United States
(12) Patent Application Publication
(10) Pub. No.: US 2011/0096268 A1
(43) Pub. Date: Apr. 28, 2011

(54) BACKLIGHT MODULE WITH AN IMPROVEMENT SOCKET TO FIX A LAMP TUBE AND LCD USING THE SAME

(75) Inventors: Tun-hao Hsu, Hsin-Chu City (TW); Hsin-li Chen, Hsin-Chu City (TW); Cheng-ju Chuang, Hsin-Chu City (TW); Chao-chih Wei, Hsin-Chu City (TW)

(73) Assignee: AU Optronics Corp., Hsin-Chu (TW)

(21) Appl. No.: 12/912,669

(22) Filed: Oct. 26, 2010

(30) Foreign Application Priority Data
Oct. 27, 2009 (TW) 098136368

(51) Int. Cl. G02F 1/13357

(52) U.S. Cl. 349/70; 362/97.2

(57) ABSTRACT

A backlight module includes a bezel, a lamp tube for generating light in response to a driving signal, and a lamp socket disposed on the bezel for holding the lamp tube. The lamp tube includes a lamp body and a connecting terminal. The lamp socket includes a lamp holder and a conductive element. The lamp holder includes an accommodating space for accommodating part of the lamp body and the connecting terminal of the lamp tube. The conductive element includes a first connector having a pair of attaching members on the top of the conductive element, and a second connector for electrically connected to the inverter. The attaching members contact the connecting terminal so as to form a path to deliver driving signal from the inverter to the connecting terminal of the lamp tube through the conductive element. Part of the conductive element is enclosed and is secured by the lamp holder.

### BACKGROUND OF THE INVENTION

1. Claim of Priority

This application claims priority to Taiwanese Patent Application No. 098136368 filed on Oct. 27, 2009.

2. Field of the Invention

The present invention relates to a backlight module utilized in a liquid crystal display (LCD) device, and more particularly, to a backlight module with an improvement socket to fix a lamp tube.

3. Description of Prior Art

With a rapid development of monitor types, novel and colorful monitors with high resolution, e.g., liquid crystal displays (LCDs), are indispensable components used in various electronic products such as monitors for notebook computers, personal digital assistants (PDAs), digital cameras, and projectors. The demand for the novelty and colorful monitors has increased tremendously.

For an ordinary LCD, a backlight module is disposed on the back of the display panel to provide light. The backlight module comprises a plurality of cold cathode fluorescent lamps (CCFLs) which are arranged in parallel arrays. In a tendency to achieve cost saving of a backlight module, cold cathode fluorescent lamps are welded on lamp holders and secured with rubber pads to fix CCFLs. The manpower which is required to weld, however, leads to comparatively high costs.

In order to solve the problem occurred by welding, a socket is additionally adopted in a backlight module to fix lamp holders. Referring to FIG. 1, a backlight module 1 comprises a plurality of cold cathode fluorescent tubes (CCFLs) 10. The plurality of cold cathode fluorescent tubes (CCFLs) 10 are locked between a pair of upper supports 30 and a pair of lower supports 20. The upper supports 30 and the lower supports 20 can be locked onto a substrate 18. Both of the two terminals of the CCFLs 10 have external electrodes 14. The CCFLs 10 are cylindrical in shape.

In order to transmit electric power to the CCFLs 10, as shown in FIG. 2, a conductive slice 26 for connecting to external electrodes 14 is disposed on the top of each of the lower supports 20. Each of the lower supports 20 comprises a supporting base 22 with a row of block divisions 23 to accommodate a plurality of pads 24 to make the conductive slice 26 be fixed onto the supporting base 22. The conductive slice 26 comprises a plurality of curved sections 28 where the CCFLs 10 are placed. Each of the curved sections 28 has a curve (not shown) to accommodate an external electrode 14. The upper supports 30, as the same as the lower supports 20, have a conductive slice 26 thereon. As shown in FIG. 1, the upper supports 30 and the lower supports 20 are used to clamp the CCFLs 10. The design of the supporting base 22, however, has some problems such as dust and noise as well as possibility of detachment in fixing. In addition, plastics rather than rubber is mostly used in fabricating the supporting base 22 so the supporting base 22 lacks functions of vibration absorption, sealing, and flexible fastening which rubber possesses.

### SUMMARY OF THE INVENTION

It is therefore an object of the present invention to provide a backlight module with an improvement socket to fix a lamp tube to solve problems occurred in the prior art.

According to the present invention, a backlight module comprises a bezel, a lamp tube, and a lamp socket. The lamp tube is used for generating light in response to a driving signal; an inverter, the lamp tube comprising a lamp body and a connecting terminal connected thereto. The lamp socket which disposed on the bezel for holding the lamp tube comprises a lamp holder and a conductive element. The lamp holder with an accommodating space is used for accommodating part of the lamp body and the connecting terminal of the lamp tube. The conductive element comprises a first connector with a pair of attaching members which are protruded from two opposite sides of the accommodating space to contact the connecting terminal. The conductive element and the lamp holder are formed monolithically and part of the conductive element enclosed by the lamp holder.

In one aspect of the present invention, the backlight module further comprises an inverter for generating the driving signal. The conductive element further comprises a second connector linked to the first connector, for electrically connected to the inverter to form a path via which the driving signal is delivered to the lamp tube. The first connector and the second connector are formed monolithically and. The lamp holder further comprising an inverter clamping member located under the lamp holder, the inverter clamping member comprises an opening, the second connector extends towards the inside of the opening, and the inverter penetrates the opening to contact the second connector. The profile of the accommodating space fits to the lamp body.

In another aspect of the present invention, the lamp holder is made of rubber. The pair of attaching members substantially form two U or V shapes at opposite ends at the bottom.

In yet another aspect of the present invention, the lamp socket further comprises a holding board located under the lamp holder, the bezel comprises a securing hole whose area is smaller than an area of the holding board, so that the lamp socket is fixed onto the bezel when the bezel is located between the holding board and the lamp holder.

In still another aspect of the present invention, the connecting terminal is a cap or a wire, and the attaching members directly press the cap or the wire. The lamp tube is a cold cathode fluorescent tubes (CCFL) or a hot cathode fluorescent tubes (HCFL).

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 shows a conventional backlight module.

FIG. 2 shows a conductive slice connecting to external electrodes disposed on the top of a lower support.

FIG. 3 illustrates an enlarged diagram of a backlight module according to a preferred embodiment of the present invention.

FIG. 4 shows a side view of the backlight module in FIG. 3 along the direction of Arrow A.

FIG. 5 is an assembled diagram of the lamp socket in FIG. 3 according to a first embodiment of the present.

FIG. 6 is a dissembled diagram of the lamp socket in FIG. 5.

FIG. 7 is an assembled diagram of a lamp socket according to a second embodiment of the present invention.

FIG. 8 is an assembled diagram of a lamp socket according to a third embodiment of the present invention.

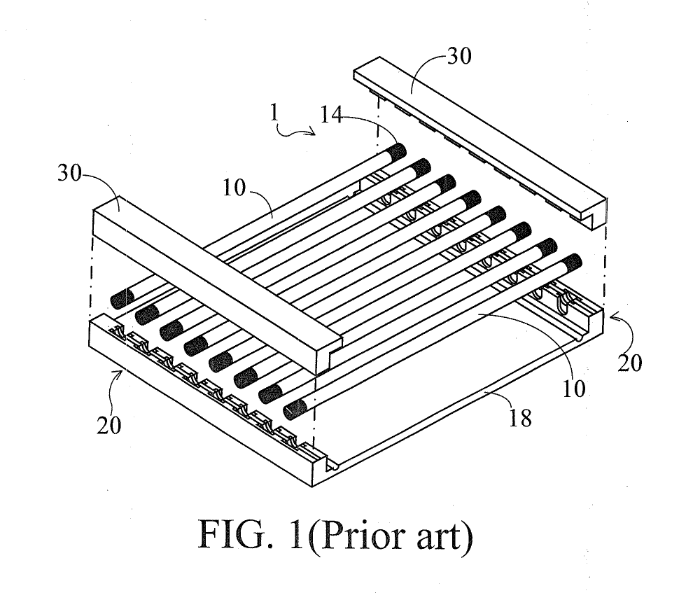

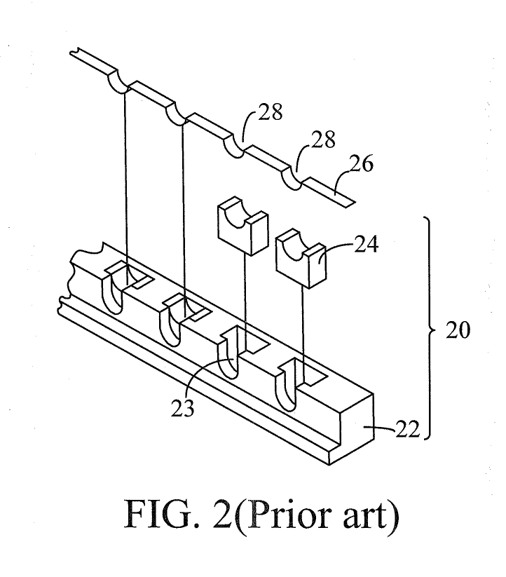

### DETAILED DESCRIPTION OF THE PREFERRED EMBODIMENTS

Referring to the attached figures, the following embodiments are illustrated to exemplify certain embodiments that the present invention can be applied to. The directional terms adopted in the present invention, such as upper, lower, front, back, left, right, top, and bottom, are defined merely according to the attached figures. Hence, the usage of the directional terms is to assist in elaborating, instead of confining, the present invention for better understanding.

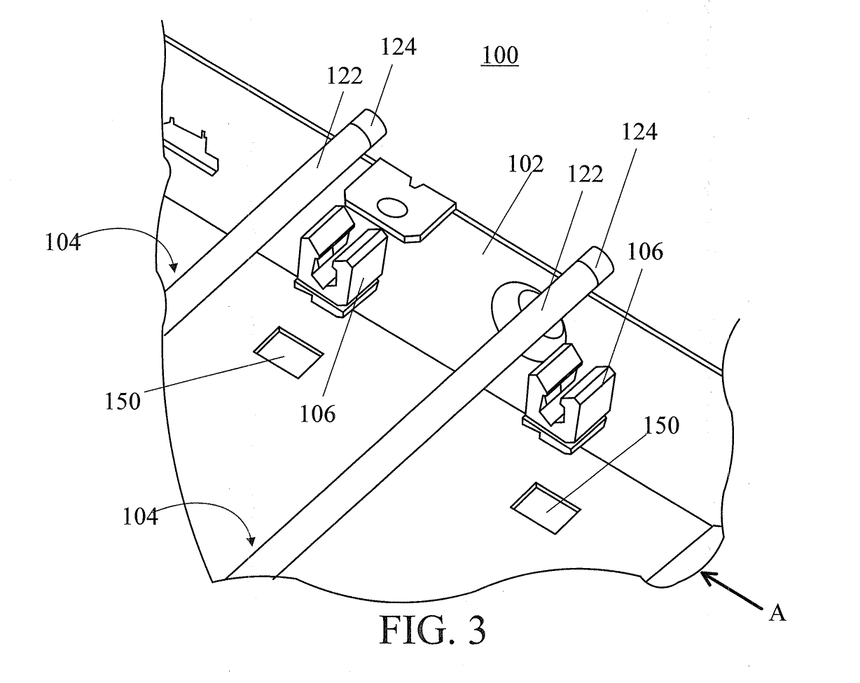

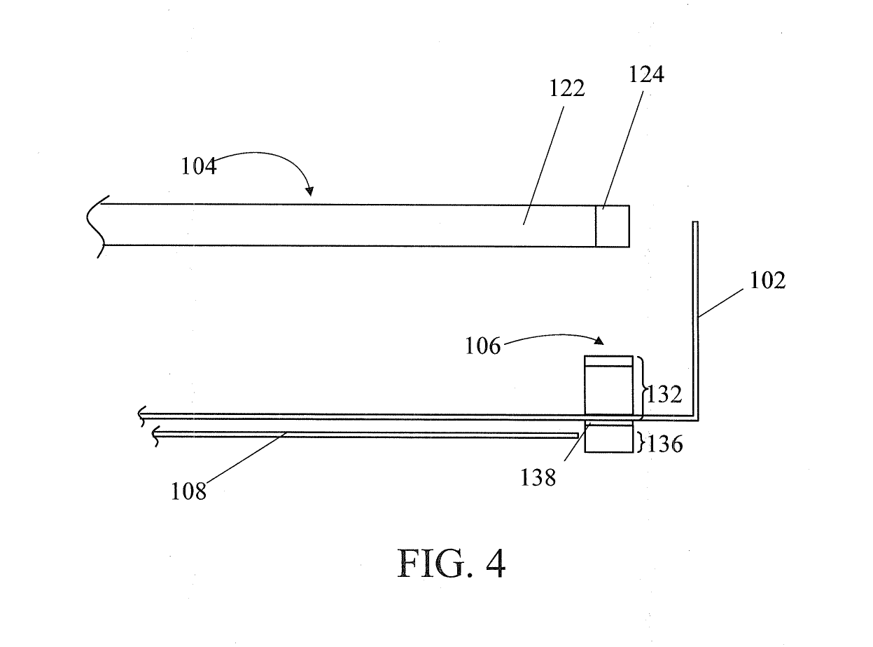

Referring to FIG. 3 and FIG. 4, FIG. 3 illustrates an enlarged diagram of a backlight module 100 according to a preferred embodiment of the present invention, and FIG. 4 shows a side view of the backlight module 100 in FIG. 3 along the direction of Arrow A. The backlight module 100 is used in liquid crystal display (LCD) device. The backlight module 100 comprises a bezel 102, a plurality of lamp tubes 104, an inverter 108, and lamp sockets 106. The lamp tubes can be cold cathode fluorescent tubes (CCFLs) or hot cathode fluorescent tubes (HCFLs). Each of the lamp tubes 104 shaped like a cylinder comprises a lamp body 122 and connecting terminals 124 at the both ends of the lamp body 122. The connecting terminals 124 are either a cap or a wire. The lamp socket 106 which is positioned on a securing hole 150 of the bezel 102 comprises a lamp holder 132, a conductive element 134, an inverter clamping member 136, and a holding board 138. The lamp socket 106 clamps the connecting terminal 124 to fix the lamp tube 104. The holding board 138 is located under the lamp holder 132 and between the lamp holder 132 and the inverter clamping member 136. The area of the holding board 138 is slightly larger than that of the securing hole 150 and the holding board 138 can be inserted into the securing hole 150 to hold the bezel 102 with the lamp holder 132 cooperatively without using additional fixing member such as screw or adhesive, so that the lamp socket 106 can be fixed onto the bezel 102 when the bezel 102 is located between the holding board 138 and the lamp holder 132 and that the inverter clamping member 136 can penetrate the securing hole 150 at the same time (as shown in FIG. 4).

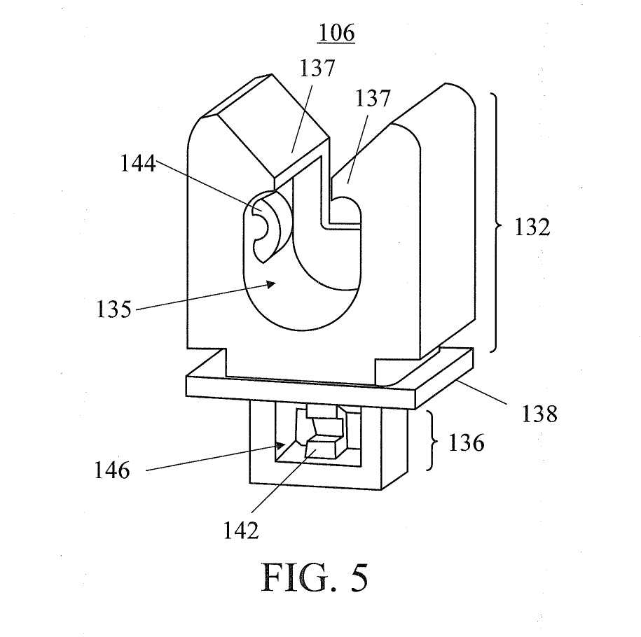

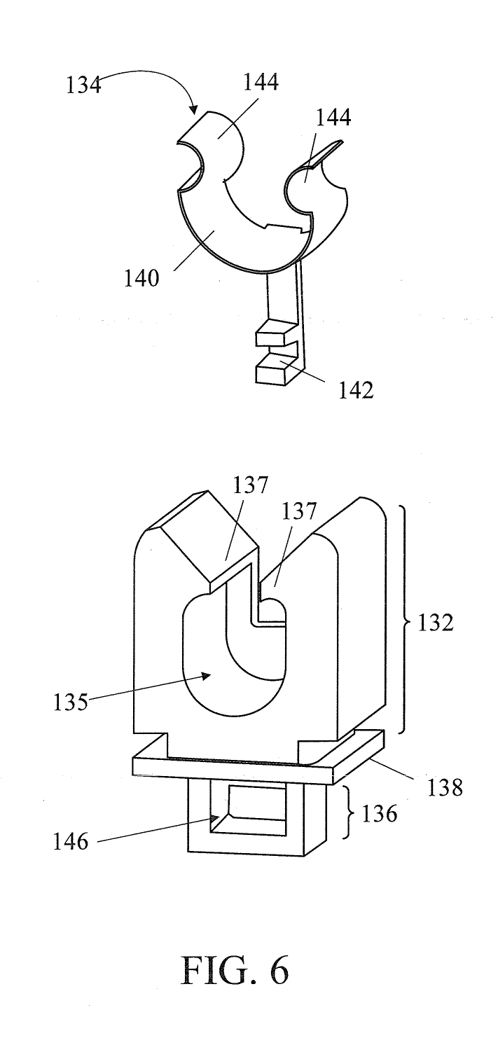

Referring to FIG. 5 and FIG. 6, FIG. 5 is an assembled diagram of the lamp socket 106 in FIG. 3 according to a first embodiment of the present, and FIG. 6 is a dissembled diagram of the lamp socket 106 in FIG. 5. The lamp holder 132 has an accommodating space 135 where part of the lamp body 122 of the lamp tube 104 and the connecting terminal 124 are housed. Preferably, the lamp holder 132 is made of elastic material such as rubber, and a hook 137 is arranged on the upper edge of the lamp holder 132. The exertion of a small force on the lamp tube 104 is required to facilitate pressing the lamp tube 104 into the accommodating space 135. The hook 137 prevents the lamp tube 104 from disengaging from the accommodating space 135 once the backlight module 100 vibrates. In the present embodiment, both of the lamp body 122 of the lamp tube 104 and the connecting terminal 124 are cylindrical. In order to fix the lamp tube 104 more appropriately, the profile of the accommodating space 135 of the lamp holder 132 fits to the lamp body 122 and appears ring-shaped. In other words, when the lamp body 122 of the lamp tube 104 and the connecting terminal 124 are rectangular in shape, the profile of the accommodating space 135 is designed to appear rectangular as well.

The conductive element 134 comprises a first connector 140 and a second connector 142, which is preferably Y-shaped. The conductive element 134 and the lamp holder 132 are formed monolithically, such as formed by co-injection process, so that the conductive element 134 and the lamp holder 132 can affix compactly. Furthermore, using glue (not shown) between the conductive element 134 and the lamp holder 132 is feasible to facilitate adhesion. Part of the conductive element 134 is covered by the lamp holder 132, and part of the conductive element 134 is exposed. for example, the first connector 140 has a pair of arc-shaped attaching members 144 protruding out of two opposite sides of the accommodating space 135. The pair of attaching members 144 directly contacts the connecting terminal 124 of the lamp tube 104. Because the connecting terminal 124 slightly presses the pair of attaching members 144, the contraction of the pressed attaching members 144 is able to enhance the electrical connection between the pair of attaching members 144 and the connecting terminal 124 of the lamp tube 104. As a result, a better electrical connection is achieved in the present invention than in the prior art. The pair of attaching members 144 generally form two U or V shapes at opposite ends at the bottom. The inverter clamping member 136 comprises an opening 146. The opening 146 and the accommodating space 135, respectively, are located at the two opposite sides of the bezel 102. The second connector 142 extends towards the inside of the opening 146, and the inverter 108 penetrates the opening 146 so as to connect the second connector 142. Because the second connector 142 and the first connector 140 are formed into one piece and substantially appear as Y-shaped, drive signals generated by the inverter 108 are transmitted to the first connector 140 and then to the connecting terminal 124 of the lamp tube 104 via the second connector 142. The lamp body 122 produces light in response to the drive signals. The conductive element 134, made of either metal or other conductive materials, is manufactured by shaping a metal film or by a series of coating, sputtering, dipping, or plating processes on a metal or non-metal film.

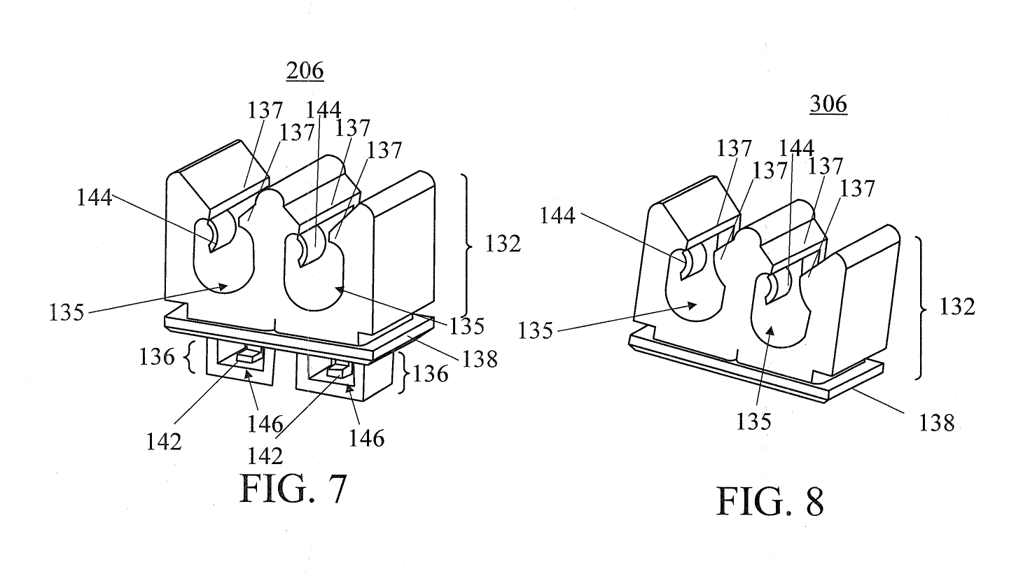

Referring to FIG. 7, an assembled diagram illustrates a lamp socket 206 according to a second embodiment of the present invention. It is noted that, for simplicity, elements in FIG. 7 that have the same function as that illustrated in FIG. 5 are provided with the same item numbers as those used in FIG. 5. The lamp socket 206 resembles a plurality of lamp sockets 106 merged together to appear all-in-one, instead of demonstrating independent lamp sockets 106. The present embodiment is suitable to apply when the lamp tubes 104 are more densely arranged.

Referring to FIG. 8, an assembled diagram illustrates a lamp socket 306 according to a third embodiment of the present invention. It is noted that, for simplicity, elements in FIG. 8 that have the same function as that illustrated in FIG. 5 are provided with the same item numbers as those used in FIG. 5. The lamp socket 306 omits the inverter clamping member 136 and the second connector 142 possessed by the lamp socket 106. The lamp socket 306 of this embodiment is mainly used to connect the low-voltage end of the lamp tubes 104. Because each of the lamp tubes 104 is mostly connected to the grounding end, the electric potential of the low-voltage end of each of the lamp tubes 104 is consistent. Thus, the inverter clamping member 136 and the second connector 142 connected with the inverter 108 can be canceled. Each of the conductive elements 134 can be connected in series and joined to the grounding end as well.

Compared to the prior art, the rubber lamp holder 132, the inverter clamping member 136, and the conductive element 134 are fabricated together in the present invention so that the lamp holder 132, the inverter clamping member 136, and the conductive element 134 can be closely integrated with one another. The first connector 140 of the conductive element 134 is resilient and has a function in clamping the connecting terminal 124 of the lamp tube 104 closely, and the second connector 142 and the inverter 108 are electrically connected. The lamp holder 132 made of rubber material is mainly used to fix the lamp tube 104 onto the bezel 102 and to protect the conductive element 134 and the lamp tube 104 from being affected by external physical impacts. In addition, the lamp holder 132 made of rubber can act as a buffer.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A backlight module comprising:
a bezel;
a lamp tube for generating light in response to a driving signal, the lamp tube comprising a lamp body and a connecting terminal connected thereto; and
a lamp socket disposed on the bezel for holding the lamp tube, comprising:
a lamp holder with an accommodating space for accommodating part of the lamp body and the connecting terminal of the lamp tube; and
a conductive element comprising a first connector with a pair of attaching members protruding from two opposite sides of the accommodating space to contact the connecting terminal, the conductive element and the lamp holder formed monolithically and part of the conductive element enclosed by the lamp holder.

2. The backlight module of claim 1 further comprising an inverter for generating the driving signal.

3. The backlight module of claim 2 wherein the conductive element further comprising a second connector linked to the first connector, for electrically connected to the inverter to form a path via which the driving signal is delivered to a lamp tube.

4. The backlight module of claim 3 wherein the first connector and the second connector are formed monolithically.

5. The backlight module of claim 3 wherein the lamp holder further comprising an inverter clamping member located under the lamp holder, the inverter clamping member comprises an opening, the second connector extends towards the inside of the opening, and the inverter penetrates the opening to contact the second connector.

6. The backlight module of claim 3 wherein the second connector and the first connector substantially appear as Y-shaped.

7. The backlight module of claim 1 wherein the connecting terminal is a cap or a wire, and the attaching members directly press the cap or the wire.

8. The backlight module of claim 1 wherein the lamp tube is a cold cathode fluorescent tubes (CCFL) or a hot cathode fluorescent tubes (HCFL).

9. The backlight module of claim 1 wherein the lamp holder is made of rubber.

10. The backlight module of claim 1 wherein the profile of the accommodating space fits the lamp body.

11. The backlight module of claim 1 wherein a pair of hooks are formed on a top of the lamp holder for fixing the lamp tube.

12. The backlight module of claim 1 wherein the lamp socket further comprises a holding board located under the lamp holder, the bezel comprises a securing hole whose area is smaller than an area of the holding board, so that the lamp socket is fixed onto the bezel when the bezel is located between the holding board and the lamp holder.

13. The backlight module of claim 1 wherein the pair of attaching members substantially form two U or V shapes at opposite ends at the bottom.

14. The backlight module of claim 1 further comprising glue between the conductive element and the lamp holder.

15. A liquid crystal display device comprising the backlight module of claim 1.
